(19) United States
(12) Patent Application Publication
(10) Pub. No.: US 2008/0153472 A1
(43) Pub. Date: Jun. 26, 2008

(54) SYSTEMS AND METHODS FOR A CELLULAR PHONE GATEWAY

(75) Inventor: Christopher K. Karstens, Apex, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, ARMONK, NY (US)

(21) Appl. No.: 11/614,693

(22) Filed: Dec. 21, 2006

(51) Int. Cl. H04M 3/42

(52) U.S. Cl. 455/417

(57) ABSTRACT

Systems and methods for a cellular phone gateway. Exemplary embodiments include cellular gateway systems and methods, including a cellular phone, a cellular tower and a cellular gateway device disposed between the cellular phone and the cellular tower, the gateway device establishing a connection between the cellular phone and the cellular device in response to a failed connection between the cellular phone and the cellular tower.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to cellular phones, and particularly to systems and methods for a cellular phone gateway.

2. Description of Background

Cellular telephones provide convenience and safety to customers by giving customers the ability to make and receive telephone calls from any location where cellular services are available. Poor or no cell phone service due to an obstruction or distance to a tower can interfere with this convenience and safety. For example, often no cell service is available in a building due to the building structure itself (e.g., metal, concrete, etc). However, once the consumer steps outside the building, service may be 100% strong. In such cases consumers often use alternate wired communications (e.g., broadband phone, etc.). Cell phone service providers do not want consumers to use alternate communications as it potentially affects their revenue stream.

As such, there is a need to compensate for disrupted cellular phone service.

### SUMMARY OF THE INVENTION

Exemplary embodiments include a cellular gateway method, including assigning an identifier to a cellular phone, programming the identifier into cellular phone remotely over a network, wherein the identifier is managed such that the identifier can exist on one cellular phone at a time, transferring the identifier to an alternate cellular device in response to disrupted service on the cellular phone and establishing a cellular gateway between the cellular phone and the alternate cellular device and between the alternate cellular device and the network.

Additional exemplary embodiments include a cellular gateway method, including establishing a connection between a network and a cellular router, configuring the cellular router to communicate with a tower-range cellular tower, pairing the cellular router with the tower-range cellular tower, initiating a cellular call on a cellular phone, broadcasting cellular packets from the cellular phone to the cellular router, exchanging packets between the network and the tower range cellular router, exchanging packets between the cellular phone and the cellular tower and exchanging acknowledgements between the cellular tower and the cellular phone via the cellular router.

Further exemplary embodiments include a cellular gateway system, including a cellular phone, a cellular tower and a cellular gateway device disposed between the cellular phone and the cellular tower, the gateway device establishing a connection between the cellular phone and the cellular device in response to a failed connection between the cellular phone and the cellular tower.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically a cellular phone gateway has been established in which a cellular phone can be routed to a different cellular device or be routed through another cellular device in which packets are used to transmit call information.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of an exemplary system for providing cellular phone gateway services.

FIG. 2 illustrates an exemplary cellular phone gateway method implementing a unique identifier; and

FIG. 3 illustrates an exemplary cellular phone gateway method implementing cellular phone packet management.

The detailed description explains the preferred embodiments of the invention, together with advantages and features, by way of example with reference to the drawings.

### DETAILED DESCRIPTION OF THE INVENTION

Exemplary embodiments include systems and methods for a cellular phone gateway. In general, a consumer's personal cellular phone provides a unique ID to a gateway, and is able to participate on the cellular network. At that point, the cellular phone can be considered a dumb Voice-Over-Internet-Protocol (VOIP) handset while it is connected to the network. The consumer can then dial the personal cellular phone and press the send button. The data is sent to the gateway, which forwards it to the appropriate gateway cellular phone. The gateway cellular phone is participating on the actual cell phone network and dials the number. The gateway service is the bridge between the actual cell phone network and the consumer's local network (e.g., Ethernet) and the gateway handles the cellular network to local network (and vice versa) for voice/data or other translation. In exemplary implementations, packets are implemented that contain routing information and data. Networks can be implemented in between a cellular tower and a cellular phone to allow the use of packets for cellular communication. In this way, cellular phone service can occur where obstructions or tower distance can interfere with cellular service.

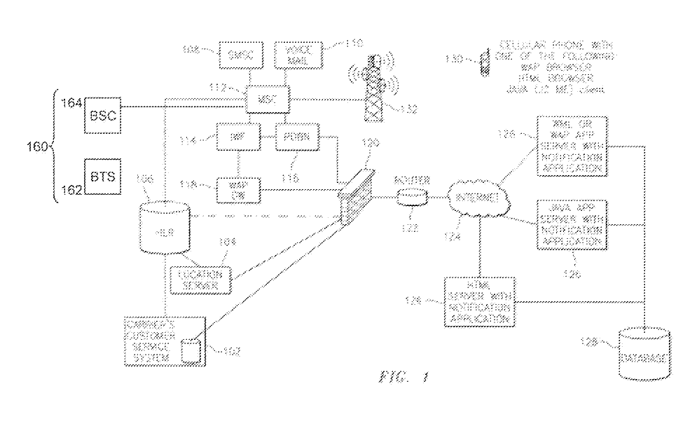

FIG. 1 is a block diagram of an exemplary system for providing cellular phone gateway services. Examples of system can include CDMA2000 (Code Division Multiple Access 2000) UMTS (Universal Mobile Telecommunication System), and PCS (Personal Communication System). The system includes a cellular telephone 130 containing connection software such as a wireless application protocol (WAP) browser or a hypertext markup language (HTML) browser when a cellular phone gateway application resides on an application server 126. Alternatively, the cellular telephone 130 may include a Java client (e.g. J2ME, binary runtime environment for wireless (BREW), other similar client) or any other type of client known in the art when portions of the cellular phone gateway reside in the cellular telephone 130 and other portions of the cellular phone gateway application reside on an application server 126. The system depicted in FIG. 1 includes a standard wireless telephone network environment with elements including a base station 132 for receiving telephone calls from cellular telephones 130, a mobile switching center (MSC) 112 in communication with a short messaging service center 108 (SMSC), a voice mail system 110, a home location register 106 (HLR), an IWF 114 and a packet data backbone network 116 (PDBN). The IWF 114 is also in communication with a wireless application protocol gateway 118 (WAP GW).

The system can further include a base station controller BSC 164 coupled to a base station transceiver subsystem BTS 162, which can be in communication with cellular phone 130. As discussed above, the HLR 106 interacts with the MSC 112 to perform subscriber management and call switching. The MSC 112 can be coupled to BSC 164, which is coupled to BTS 162. In general, BSC 164 and BTS 162 can be collectively termed BS 160.

The MSC 112 controls connection to the BSC 164, the PSTN and the PLMN (Public Land Mobile Network). The BSC 164 controls the radio links, and handoffs. The BTS 162 establishes radio links with the cellular phone 130 and manages radio resources. The HLR 106 performs subscriber location registration and serves as a subscriber information database. In general, upon call set-up, the BTS 162 assigns channels to the cellular phone 130, and communication paths are established between the BTS 162 and a BSC 164, between the BSC 164 and an MSC 112, and between the MSC 112 and an internal network or an external network (e.g., the PSTN, or tower 132). A call is connected via the communication paths. If a call cannot continue due to adverse radio environment conditions or a shadow area, the call is discontinued forcedly. As such, as discussed further below, cellular phone gateways can be established. Such cellular phone gateways can include programming the phone to receive calls at multiple numbers as mapped by the gateway. In another exemplary embodiment, available networks can be used to transmit cellular phone call data via a network while cellular phone service is not present.

The HLR 106, as is known in the art, includes a database of customer (subscriber) information including customer profiles utilized in mobile (cellular) networks. In addition, the HLR 106 accesses customer information from the carrier's customer service system 102 and a location server 104. In exemplary embodiments, the HLR 106 records whether the customer is a subscriber to the cellular phone gateway service. If the customer is a subscriber, the HLR 106 sends a message to the status cellular phone gateway application via a network 124, such as the Internet, when the customer telephone 130 is powered on and in the mobile network. In exemplary embodiments, the HLR 106 sends information to the cellular phone gateway application through a firewall 120 and via a router 122 and the network 124. HLR 106 can also temporarily store information about the cellular phone 130 within the service areas of the MSC 112. If the cellular phone 130 moves into a different service area, the stored information about the cellular phone 130 can be deleted.

In alternate exemplary embodiments, the location server 104 extracts base station 132, or cell site, location information from the HLR 106 and device specific location information (e.g., GPS based location) from the device, or telephone 130. The location server 104 may then make this location information available to the application servers 126. Alternatively, the HLR 106 may take the location information from the location server 104 and send it to the application servers 126.

The network 124 depicted in FIG. 1 may be any type of known network including, but not limited to, a wide area network (WAN), a local area network (LAN), a global network (e.g. Internet), a virtual private network (VPN), and an intranet. The network 124 may be implemented using a wireless network or any kind of physical network implementation known in the art.

FIG. 1 also includes a database for storing cellular phone gateway application data. The storage device 128 depicted in FIG. 1 may be implemented using a variety of devices for storing information. It is understood that the storage device 128 may be implemented using memory contained in one or more of the server systems 126 or it may be a separate physical device. The storage device 128 is logically addressable as a consolidated data source across a distributed environment that includes a network 124. The physical data accessed via the storage device 128 may be located in a variety of geographic locations depending on application and access requirements. Information stored in the storage device 128 may be retrieved and manipulated via the server systems 126. The storage device 128 includes a cellular phone gateway database. In exemplary embodiments, the cellular phone gateway database is relational and includes one or more records correlating multiple cellular phone numbers that can be interchanged to receive calls at multiple numbers. The storage device 128 may also include other kinds of data such as information concerning the creating and modification of the cellular phone gateway database records (e.g., date and time of creation). In exemplary embodiments, one or more of the server systems 126 operate as a database servers and coordinate access to application data including data stored on storage device 128.

In exemplary embodiments, database 128 or another information database, can further include information on known “dead spots”. Such known “dead spot” information can allow the system to automatically configure the gateway as the user comes into a known “dead spot”. By querying a “dead spot” database, cellular carriers can also automatically make necessary adjustments related to gateways in known “dead spot” areas.

The application servers 126 execute one or more computer programs to facilitate the cellular phone gateway process. The processing is described in more detail below and may include having all of the notification application residing on the server 126 or sharing the processing of the notification application between the server 126 and the cellular telephone 130. All or portions of the notification application may be located on a server 126 such as a wireless markup language (WML) or wireless application protocol (WAP) server, an HTML server, a Java application server, or a BREW application server. In exemplary embodiments, portions of the notification application may also be located on the cellular telephone 130.

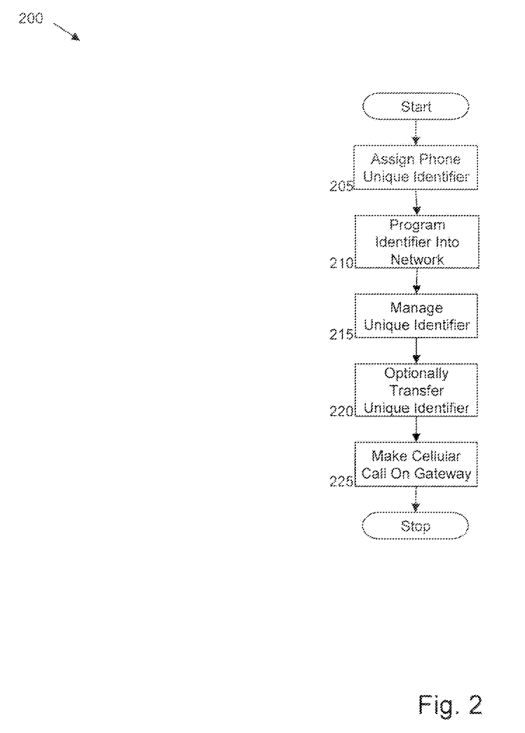

FIG. 2 illustrates an exemplary cellular phone gateway method 200 implementing a unique identifier. At step 205, the cellular phone can be assigned a unique identifier, which can be represented in software and stored in one of the exemplary implementations as discussed above. In general, the unique identifier is programmed into the cellular phone remotely over a network (e.g., Ethernet network, etc.) at step 210.

At step 215, the unique identifier is managed such that the unique identifier exists on one cellular phone at a time. In general, this feature can also be enforced on the service provider side (e.g., their network does not permit duplicate unique identifiers).

At step 220, a user can temporarily transfer the unique identifier from a cellular phone device that has poor or no cellular phone service to another cellular phone device with known good service. For example, inside a building there may be no cellular service available. However, on the roof of that same building there may be 100% perfect service. As such, a device on roof of the building can be used as a gateway. At step 225, the user can make a phone call via the gateway.

It is therefore appreciated that a software VOIP/data/other gateway service that has two programmable cellular phones/devices as a basis. A consumer can log into the gateway, provide their cell phone's unique identifier(s), and connect to that newly programmed phone over a network (e.g., Ethernet) for communications (i.e. VOIP/data).

As discussed further below, the consumer's personal cellular phone can connect to a local network (e.g., Ethernet network) directly or through another device (e.g., Laptop connected to the Ethernet network). The consumer's personal cellular phone could be instructed to automatically log onto the gateway when it can be detected and establish the relationship. When the consumer's cell phone breaks the relationship with the gateway, the unique identifier is removed from the gateway cellular phone/device, and restored on the consumer's personal cellular phone.

In general, when a consumer's personal cell phone has given its Unique ID to a gateway, it can participate on the cellular network at this time. It can be considered a dumb VOIP handset at this time. The consumer then dials personal cell phone and presses send. This data is sent to the gateway, which forwards it to the appropriate gateway cell phone. The gateway cellular phone is participating on the actual cellular phone network and dials the number. The gateway service is the bridge between the actual cellular phone network and the consumer's local network (e.g., Ethernet); and the gateway handles the cellular network to local network (and vice versa) voice/data/other translation.

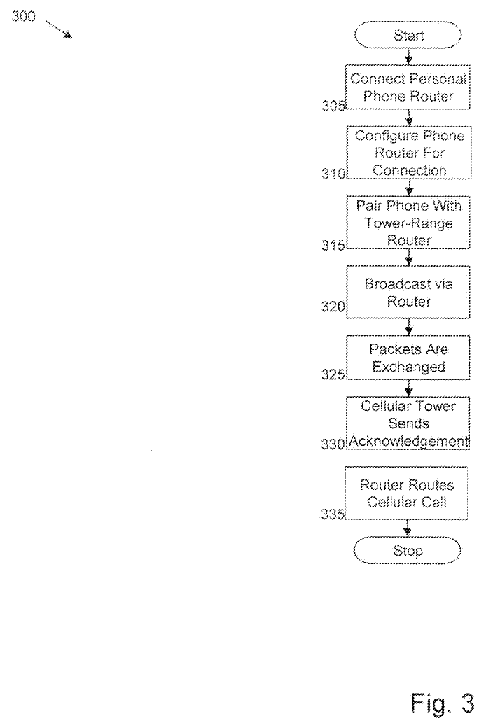

FIG. 3 illustrates an exemplary cellular phone gateway method 300 implementing cellular phone packet management. As mentioned above, a gateway implementing packets can be established between a cellular phone and another device.

At step 305, the user can connect personal cell router (laptop, device connected to a laptop, or standalone device, general purpose computer, etc.) to network. At step 310, the user configures personal cell router to communicate with tower-range cell router. At step 315, the cellular phone is then paired with tower-range router. When the user powers on the cellular phone, the cellular phone broadcasts power on packet to the personal cellular router via cell phone transmitter or packet compatible with personal cell router at step 320.

At step 325, the packet goes over the network to tower-range cell router. In addition, the cellular phone transmitter sends packet to cellular tower. The cellular tower then sends acknowledgment at step 330. At step 335, the tower-range cellular router receives directed acknowledgement and routes it only to personal cellular router. Furthermore, the personal cellular router broadcasts acknowledgement to the cell phone via transmitter or packet compatible with cell phone.

In general, it is appreciated that the cellular routers not altering the cell packets. The routers are encapsulating them to be sent over a network and de-encapsulating them to transmit to the actual tower or actual cell phone.

Outbound packets from cell phones are being encapsulated by the personal cell router to travel over a network to a tower-range cell router, then these packets are de-encapsulated and broadcast with cell specific equipment (transmit power is that of a hand held cell phone). Tower-range cell router can work with one to many transmitters. It can route packets to transmitters based on transmitter availability.

Inbound directed packets from cell towers are received by the tower-range cell router. The routing info is copied out of the cell packet. The packet is encapsulated and sent only to the paired cell phone's personal cell router. The personal cell router de-encapsulates the packet and braodcasts the packet to the cell phone via transmitter or packet compatible with the cell phone. In general, transmit power may be very small (e.g., inches/feet).

Inbound non-directed packets from cell towers can be suppressed/filtered by the tower-range call router. These packets may be forwarded to zero/select/all compatible cell phones that are logged into the tower-range cell router at the time.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly enbodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A cellular gateway method, comprising:
assigning an identifier to a cellular phone;
programming the identifier into cellular phone remotely over a network, wherein the identifier is managed such that the identifier can exist on one cellular phone at a time;
transferring the identifier to an alternate cellular device in response to disrupted service on the cellular phone; and
establishing a cellular gateway between the cellular phone and the alternate cellular device and between the alternate cellular device and the network.

2. The method as claimed in claim 1 wherein establishing a cellular gateway further comprises providing the identification to the cellular gateway.

3. The method as claimed in claim 2 further comprising initiating a call on the cellular phone.

4. The method as claimed in claim 3 further comprising forwarding the call to the alternate cellular device via the cellular gateway.

5. The method as claimed in claim 4 further comprising dialing the call on the network via the alternate cellular device.

6. A cellular gateway method, comprising:
establishing a connection between a network and a cellular router;
configuring the cellular router to communicate with a tower-range cellular tower;
pairing the cellular router with the tower-range cellular tower;
initiating a cellular call on a cellular phone;
broadcasting cellular packets from the cellular phone to the cellular router;
exchanging packets between the network and the tower-range cellular router;
exchanging packets between the cellular phone and the cellular tower; and
exchanging acknowledgements between the cellular tower and the cellular phone via the cellular router.

7. The method as claimed in claim 6 wherein packets that are received by the cellular router are encapsulated for transmission over the network.

8. The method as claimed in claim 7 further comprising de-encapsulating the packets for transmission to at least one of the cellular tower and the cellular phone.

9. The method as claimed in claim 8 wherein outbound packets are encapsulated by the cellular router to travel over the network via the cellular router.

10. The method as claimed in claim 9 wherein the outbound packets are de-encapsulated are broadcast via at least one of the cellular phone and the cellular tower.

11. The method as claimed in claim 10 wherein the cellular router copies routing information from inbound packets and encapsulates the inbound packets and transmits the packets to the cellular phone.

12. The method as claimed in claim 11 wherein inbound packets from the cellular tower are filtered by the cellular router.

13. The method as claimed in claim 12 wherein the cellular router is a computer connected to the network.

14. A cellular gateway system, comprising:
a cellular phone;
a cellular tower; and
a cellular gateway device disposed between the cellular phone and the cellular tower, the gateway device establishing a connection between the cellular phone and the cellular device in response to a failed connection between the cellular phone and the cellular tower.

15. The system as claimed in claim 14 wherein the cellular gateway device is a second cellular phone in which a relationship has been established between the cellular phone and the second cellular phone by assigning an identifier to the cellular phone, programming the identifier into the cellular phone remotely over a network, wherein the identifier is managed such that the identifier can exist on the cellular phone, transferring the identifier to the second cellular phone and establishing a cellular gateway between the cellular phone and the alternate cellular device and between the second cellular phone and the network.

16. The system as claimed in claim 15 wherein establishing a cellular gateway further comprises providing the identification to the cellular gateway.

17. The method as claimed in claim 16 wherein a call initiated by the cellular phone is forwarded to the second cellular phone via the cellular gateway and dialed on the network via the second cellular phone.

18. The system as claimed in claim 14 wherein the cellular gateway is a general purpose computer in which a connection is established between the network and the general purpose computer and between the general purpose computer and a cellular tower.

19. The method as claimed in claim 18 wherein a call initiated by the cellular phone causes cellular packets from the cellular phone to be broadcast to the general purpose computer and exchanged between the network and the general purpose computer.

20. The method as claimed in claim 19 wherein packets that are received by the cellular router are encapsulated for transmission over the network and de-encapsulated for transmission to at least one of the cellular tower and the cellular phone, wherein outbound packets are encapsulated by the cellular router to travel over the network via the general purpose computer and de-encapsulated and broadcast via at least one of the cellular phone and the cellular tower, and wherein the general purpose computer copies routing information from inbound packets and encapsulates the inbound packets and transmits the packets to the cellular phone.
